(19) United States
(12) Patent Application Publication
(10) Pub. No.: US 2023/0271671 A1
(43) Pub. Date: Aug. 31, 2023

(54) FRONT FORK

(71) Applicant: Hitachi Astemo, Ltd., Hitachinaka-shi (JP)

(72) Inventors: Isao MORISHITA, Hitachinaka-shi (JP); Yuji OUCHI, Hitachinaka-shi (JP)

(73) Assignee: Hitachi Astemo, Ltd., Hitachinaka-shi (JP)

(21) Appl. No.: 18/311,036

(22) Filed: May 2, 2023

Related U.S. Application Data
(63) Continuation of application No. PCT/JP2020/047672, filed on Dec. 21, 2020.

(51) Int. Cl. B62K 25/08; B62K 21/02

(52) U.S. Cl. CPC B62K 25/08; B62K 21/02

(57) ABSTRACT

A front fork includes a shock absorber body, a fixing member, and a support portion. A length of a contact surface of the support portion in contact with the outer peripheral surface of the first cylindrical body in a circumferential direction of the first cylindrical body is smaller than a peripheral length of the outer peripheral surface. The support portion is provided at a portion where a contact surface pressure between the fixing member and the support portion increases when the vehicle decelerates.

### CROSS-REFERENCE TO RELATED APPLICATIONS

This application is a Continuation of International Patent Application No. PCT/JP2020/047672 filed on Dec. 21, 2020, the content of which is incorporated herein by reference in its entirety.

### FIELD OF THE INVENTION

The present invention relates to a front fork provided in a saddle-type vehicle and provided with a shock absorber body for damping vibration energy.

### BACKGROUND OF THE INVENTION

A front fork is mounted on a saddle-type vehicle represented by a motorcycles and a motorized tricycle. A part of energy such as vibration received from a road surface while a saddle-type vehicle is traveling is attenuated by a front fork which supports a front wheel. As a technology related to a front fork of the related art, there is a technology disclosed in JP2006-347386A, for example.

A front fork illustrated in JP2006-347386A has a configuration in which reinforcing portions are provided on front and rear surfaces of an outer tube of a shock absorber body. On the front surface of the outer tube, the reinforcing portion is provided on an outer peripheral surface of the outer tube and at a position closer to an inside of a vehicle body from a vehicle front-rear direction. On the rear surface of the outer tube, the reinforcing portion is provided on the outer peripheral surface of the outer tube and at a position which is closer to an outside of the vehicle body in the vehicle front-rear direction. As a result, bending rigidity of the front fork in the vehicle front-rear direction can be improved, and bending rigidity in a vehicle width direction can be effectively reduced.

However, depending on a type of a vehicle, in some cases, it is preferable to increase bending rigidity of a front fork during braking (when the vehicle decelerates) while not increasing rigidity during times other than deceleration from a viewpoint of preventing deterioration in traveling performance.

### SUMMARY OF THE INVENTION

An object of the present invention is to provide a front fork which can maintain traveling performance of a vehicle except when the vehicle decelerates while increasing fork rigidity when the vehicle decelerates.

As a result of intensive studies, the inventors of the present invention focused on a fact that a fixing member (bottom bracket or the like) which fixes a shock absorber body to a vehicle is in contact with an outer peripheral surface of one of a pair of cylindrical bodies (outer tube and inner tube, or the like) which make up a shock absorber body of a front fork. Then, it was found that, by providing a support portion which supports the outer peripheral surface of the cylindrical body at a portion where a contact surface pressure with the fixing member increases when the vehicle decelerates, while increasing rigidity of the front fork when the vehicle decelerates, it is possible to maintain traveling performance of the vehicle except when the vehicle decelerates. The present invention was completed based on such knowledge.

The present disclosure will be described below. According to the present disclosure, there is provided a front fork including a shock absorber body provided with a first cylindrical body formed in a cylindrical shape and a second cylindrical body movably provided relative to the first cylindrical body in an axial direction of the first cylindrical body, a fixing member which is in contact with an outer peripheral surface of the first cylindrical body so that the shock absorber body is capable of being fixed to a vehicle on which the shock absorber body is mounted, and a support portion which supports a part of the outer peripheral surface of the first cylindrical body and is in contact with the fixing member, in which a length of a contact surface of the support portion in contact with the outer peripheral surface of the first cylindrical body in a circumferential direction of the first cylindrical body is smaller than a peripheral length of the outer peripheral surface, and the support portion is provided at a portion where a contact surface pressure between the fixing member and the support portion increases when the vehicle decelerates.

According to the present invention, it is possible to provide a front fork which can maintain traveling performance of a vehicle except during deceleration while increasing rigidity of the front fork when the vehicle decelerates.

### BRIEF DESCRIPTION OF THE DRAWINGS

FIG. 1 is a side view of a motorcycle equipped with a front fork according to a first example.

FIG. 2 is a view of the front fork illustrated in FIG. 1 as seen from the line of the arrow 2.

FIG. 3 is a perspective view of a configuration around a bottom bracket of the front fork illustrated in FIG. 2, as seen from below.

FIG. 4 is a view in a direction of the arrow 4 in FIG. 3.

FIG. 5 is a view illustrating an outer tube, a bottom bracket, and a support portion illustrated in FIG. 3.

FIG. 6 is a view for illustrating the outer tube and the support portion illustrated in FIG. 3.

FIG. 7 is a view illustrating an outer tube, a bottom bracket, and a support portion of a front fork according to a second example.

FIG. 8 is a cross-sectional view taken along the line 8-8 in FIG. 7.

FIG. 9 is a view illustrating an outer tube, a bottom bracket, and a support portion of a front fork according to a third example.

FIG. 10 is a view illustrating an outer tube, a bottom bracket, and a support portion of a front fork according to a fourth example.

FIG. 11 is a view illustrating an outer tube, a bottom bracket, and a support portion of a front fork according to a fifth example.

### DETAILED DESCRIPTION OF THE INVENTION

An embodiment of the present invention will be described below with reference to the accompanying drawings. Forms illustrated in the accompanying drawings are examples of the present invention, and the present invention is not limited thereto. In the description, left and right refer to left and right with respect to an occupant in the vehicle, and front and rear refer to front and rear with respect to a traveling direction of the vehicle. In the drawings, Up indicates upper, Dn indicates lower, Fr indicates front (advancing direction, traveling direction), Rr indicates rear (direction opposite to the advancing direction), Li indicates left, and Ri indicates right.

### First Example

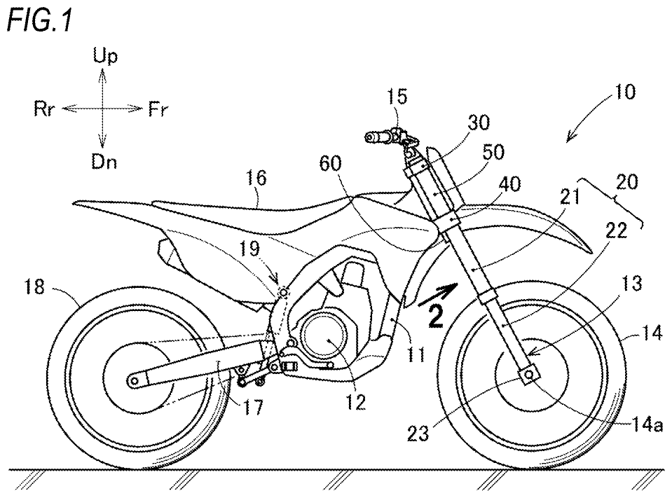

A front fork 13 according to the first example will be described with reference to FIGS. 1 to 6.

As illustrated in FIG. 1, the front fork 13 is used in a vehicle, for example, in a motorcycle 10, which is a kind of saddle-type vehicle on which a rider straddles. Hereinafter, the motorcycle 10 may be referred to as a “vehicle 10”.

The motorcycle 10 includes a vehicle body 11, an engine 12 as a power source supported at a lower center of the vehicle body 11, a front fork 13 provided in a front part of the vehicle body 11, a front wheel 14 which is a wheel supported by the front fork 13, and a steering handle bar 15 connected to the front fork 13. The motorcycle 10 is provided with a passenger seat 16 at an upper center of the vehicle body 11, and includes a wheel support mechanism 17 extending rearward from a rear part of the vehicle body 11 and capable of swinging in an up-down direction, a rear wheel 18 which is a wheel supported by the wheel support mechanism 17, and a rear suspension 19 which spans between the vehicle body 11 and the wheel support mechanism 17.

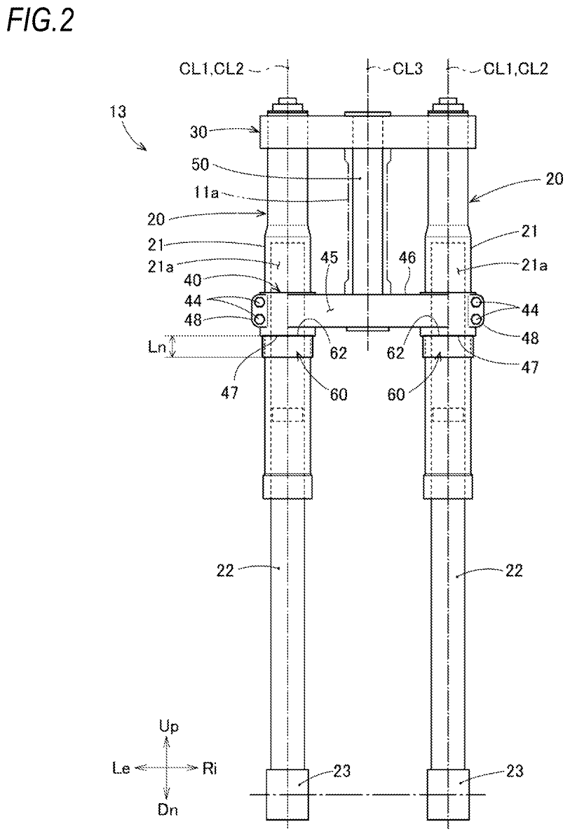

As illustrated in FIGS. 1 and 2, the front fork 13 includes two shock absorber bodies 20 and 20 (fork units 20 and 20) respectively provided on both sides of the front wheel 14, an upper bracket 30 (top bridge 30) which connects upper ends of the two shock absorber bodies 20 and 20, and a bottom bracket 40 (bottom bridge 40) which connects axially middle portions or axially lower ends of the two shock absorber bodies 20 and 20.

The shock absorber body 20 is a shock absorber including an outer tube 21 with a cylindrical shape disposed on an upper side, which is a side supported by the vehicle body 11, and an inner tube 22 with a cylindrical shape disposed on a lower side, which is the side supporting the front wheel 14. The front fork 13 provided with the shock absorber bodies 20 and 20 is an inverted fork. In general, an inverted fork can be set to have a higher bending rigidity than an upright fork.

The inner tube 22 is provided to be movable in an axis CL2 direction of the outer tube 21 with respect to the outer tube 21, and is partially disposed to be relatively movable with respect to the outer tube 21. An axle bracket 23 for supporting an axle 14a for the front wheel 14 is provided at a lower end of the inner tube 22. The axis CL2 of the outer tube 21 matches the axis CL1 of the shock absorber body 20.

Hereinafter, the outer tube 21 may be referred to as a “first cylindrical body 21”, and the inner tube 22 may be referred to as a “second cylindrical body 22”.

The upper bracket 30 connects the upper ends of the outer tubes 21 and 21 to each other. The bottom bracket 40 connects middle portions of the outer tubes 21 and 21 in the axis CL2 direction or lower ends thereof in the axis CL2 direction. A steering stem 50 with a cylindrical shape extending vertically is connected between a center of the upper bracket 30 in a width direction and a center of the bottom bracket 40 in the width direction. The steering stem 50 is rotatably supported with respect to a head pipe 11a of the vehicle body 11. An axis CL3 of the steering stem 50 is located at a center of the motorcycle 10 in a vehicle width direction, and is parallel to the axes CL1 and CL1 of the shock absorber bodies 20 and 20.

As is clear from the above description, the upper bracket 30 and the bottom bracket 40 are fixing members in contact with outer peripheral surfaces 21a and 21a of the outer tubes 21 and 21 to fix the shock absorber bodies 20 and 20 to the motorcycle 10 on which the shock absorber bodies 20 and 20 are mounted. Hereinafter, the upper bracket 30 and the bottom bracket 40 may be referred to as “fixing members 30 and 40”.

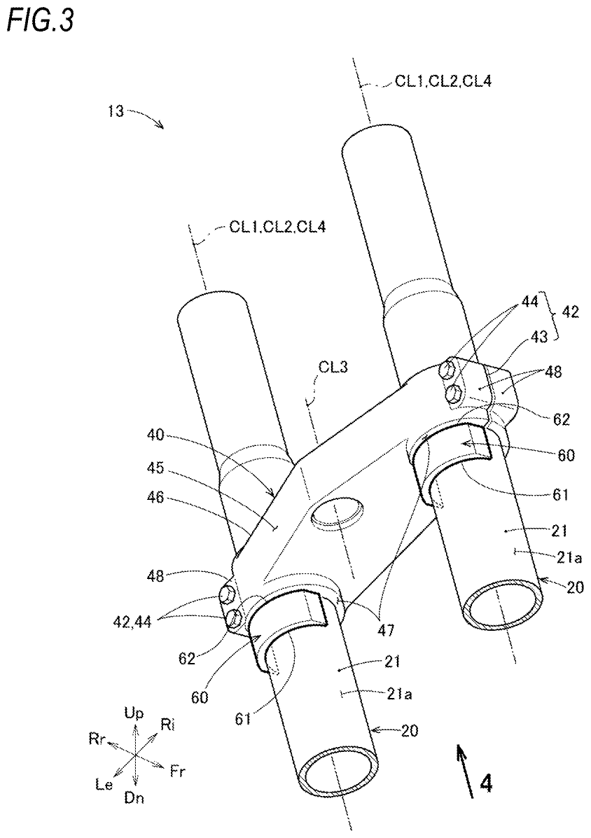

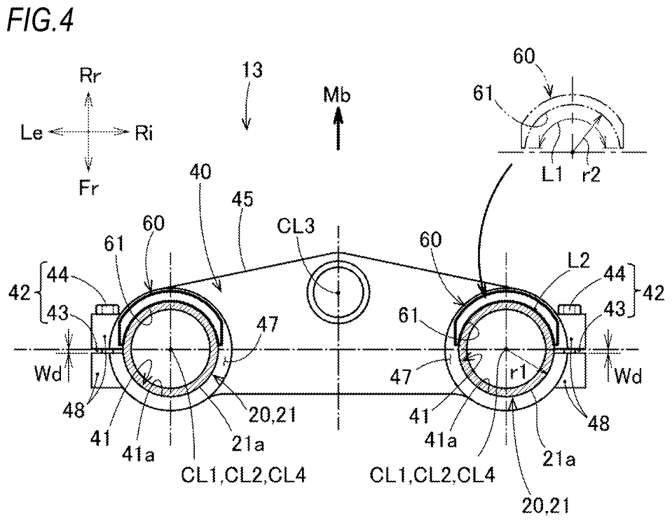

As illustrated in FIGS. 3 and 4, the bottom bracket 40 includes holes 41 and 41 which are penetrating vertically and through which the outer tubes 21 and 21 are respectively inserted, and hole diameter changing mechanisms 42 and 42 for changing hole diameters of the holes 41 and 41. Axes CL4 and CL4 of the holes 41 and 41 respectively match the axes CL2 and CL2 of the outer tubes 21 and 21.

The hole diameter changing mechanisms 42 and 42 are respectively provided with slits 43 and 43 that the bottom bracket 40 includes, and bolts 44 and 44 changing groove widths Wd and Wd of the slits 43 and 43. The slits 43 and 43 are formed in the bottom bracket 40 from inner peripheral surfaces of the holes 41 and 41 to an outer peripheral surface 45 of the bottom bracket 40, and the slits 43 and 43 extend from an upper surface 46 to a lower surface 47 of the bottom bracket 40 along the axes CL4 and CL4 of the holes 41 and 41.

The bottom bracket 40 includes flanges 48 and 48 on both sides of the slits 43 and 43 to sandwich the slits 43 and 43. The bolts 44 and 44 can adjust the groove widths Wd and Wd of the slits 43 and 43 by adjusting a tightening amount for tightening the flanges 48 and 48. Since the holes 41 and 41 respectively communicate with the slits 43 and 43, the diameters of the holes 41 and 41 are reduced by tightening the bolts 44 and 44. As a result, the outer tubes 21 and 21 can be fixed using the bottom bracket 40.

The front fork 13 is provided with support portions 60 and 60 for increasing bending rigidity of the front fork 13 when the motorcycle 10 is braked (when the motorcycle 10 decelerates).

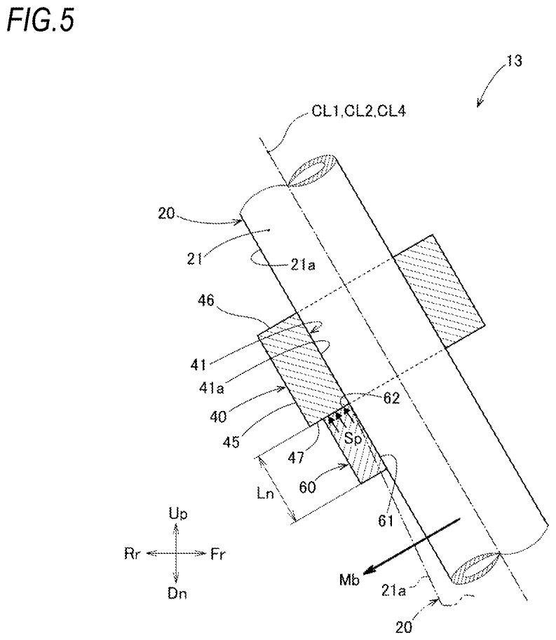

When the motorcycle 10 traveling forward decelerates, an external force is applied from the front wheel 14 to the front fork 13 in a direction (direction of arrow Rr) opposite to a traveling direction (direction of arrow Fr) of the motorcycle 10. Therefore, as illustrated in FIGS. 4 and 5, a bending moment Mb acts on each of the outer tubes 21 and 21 in a direction opposite to the traveling direction.

The front fork 13 includes the shock absorber bodies 20 and 20 which support parts of the outer peripheral surfaces 21a and 21a of the outer tubes 21 and 21 and include support portions 60 and 60 which are in contact with the bottom bracket 40. The support portions 60 and 60 are provided at portions where contact surface pressures Sp between the bottom bracket 40 and the support portions 60 and 60 increase when the traveling motorcycle 10 decelerates, that is, at portions in a direction (direction of arrow Rr) opposite to a traveling direction (direction of arrow Fr) of the motorcycle 10.

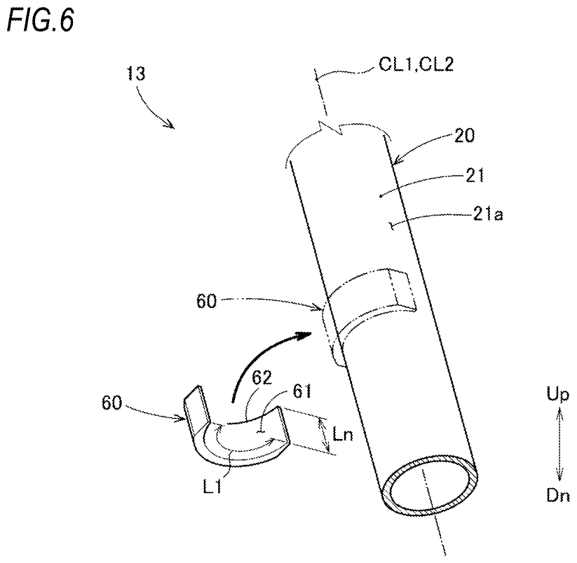

As illustrated in FIGS. 4 and 6, a length L1 of each of inner peripheral surfaces 61 and 61, which are contact surfaces of the support portions 60 and 60 in contact with the outer peripheral surfaces 21a and 21a of the outer tubes 21 and 21 in a circumferential direction of the outer tubes 21 and 21 is smaller than a peripheral length L2 of the outer peripheral surface 21a of the outer tube 21. A length Ln of each of the support portions 60 and 60 in an axis CL1 direction is set to a length necessary to increase the bending rigidity of the front fork 13. Hereinafter, the inner peripheral surface 61 of the support portion 60 may be referred to as a “contact surface 61”.

The contact surfaces 61 and 61 of the support portions 60 and 60 are in direct or indirect contact with the outer peripheral surfaces 21a and 21a of the respective outer tubes 21 and 21. The contact surfaces 61 and 61 of the support portions 60 and 60 are shaped and sized to be in surface contact with the outer peripheral surfaces 21a and 21a of the outer tubes 21 and 21 in close contact. As illustrated in FIG. 4, a radius r1 of each of the outer peripheral surfaces 21a and 21a of the outer tubes 21 and 21 and a radius r2 of each of the contact surfaces 61 and 61 of the support portions 60 and 60 are preferably the same.

At least parts of the contact surfaces 61 and 61 of the support portions 60 and 60 may be adhered to the outer peripheral surfaces 21a and 21a of the respective outer tubes 21 and 21.

As illustrated in FIGS. 3 and 5, upper surfaces 62 and 62 of the support portions 60 and 60 are flat surfaces and in contact with the lower surface 47 of the bottom bracket 40. At least parts of the lower surface 47 of the bottom bracket 40 with which the upper surfaces 62 and 62 of the support portions 60 and 60 are in contact are flat surfaces with which the upper surfaces 62 and 62 can come into surface contact.

Next, operations of the outer tube 21, the bottom bracket 40, and the support portion 60 will be described with reference to FIG. 5.

The support portion 60 is provided at a portion where the contact surface pressure Sp between the bottom bracket 40 and the support portion 60 increases when the traveling motorcycle 10 (see FIG. 1) decelerates. The upper surface 62 of the support portion 60 is supported by the bottom bracket 40 by being brought into contact with the lower surface 47 of the bottom bracket 40. By the bending moment Mb acting on the outer tube 21, bending displacement can occur in the outer tube 21 as indicated by the imaginary line. The bending displacement increases the contact surface pressure Sp between the lower surface 47 of the bottom bracket 40 and the upper surface 62 of the support portion 60. Therefore, the bending displacement of the outer tube 21 can be prevented. As a result, the bending rigidity of the outer tube 21 supported by the support portion 60 is increased, so that the rigidity (bending rigidity) of the front fork 13 when the motorcycle 10 decelerates can be increased.

The description of the front fork 13 according to the first example is summarized as follows.

The front fork 13 is equipped with two shock absorber bodies 20 and 20 each of which includes the first cylindrical body 21 formed in a cylindrical shape, and the second cylindrical body 22 provided to be movable in the axis CL2 direction of the first cylindrical body 21 with respect to the first cylindrical body 21. The front fork 13 includes the fixing member 40 in contact with the outer peripheral surface 21a of the first cylindrical body 21 to fix the shock absorber bodies 20 and 20 to the vehicle 10 on which the shock absorber bodies 20 and 20 are mounted, and the support portion 60 supporting a part of the outer peripheral surface 21a of the first cylindrical body 21 and in contact with the fixing member 40. The length L1 in the circumferential direction of the contact surface 61 of the support portion 60 which is in contact with the outer peripheral surface 21a of the first cylindrical body 21 is smaller than the peripheral length L2 of the outer peripheral surface 21a. The support portion 60 is provided at a portion where the contact surface pressure Sp between the fixing member 40 and the support portion 60 increases when the vehicle 10 decelerates.

The support portion 60 is disposed at a corner portion defined by the outer peripheral surface 21a of the first cylindrical body 21 and the lower surface 47 of the fixing member 40, and the upper surface 62 of the support portion 60 is in contact with the lower surface 47 of the fixing member 40. As a result, excessive rigidity can be avoided except when the vehicle 10 decelerates, so that the traveling performance of the vehicle can be maintained except when the vehicle decelerates.

The fixing member 40 is disposed at the central portion of the first cylindrical body 21 in the axis CL2 direction or the lower end portion in an axis CL direction. As a result, the support portion 60 can be disposed adjacent to the bottom bracket 40 where the contact surface pressure Sp tends to increase and the bending displacement is large during deceleration, so the rigidity of the front fork 13 during deceleration can be easily improved.

The support portion 60 is in contact with the lower surface 47 of the fixing member 40. Since the bending displacement during deceleration is greater on the lower side closer to the front wheel 14, there is a greater need to increase rigidity during deceleration. By bringing the support portion 60 into contact with the lower surface 46 of the fixing member 40, it becomes easier to increase the rigidity of the portion which needs to be increased in rigidity during deceleration.

The contact surface 61 of the support portion 60 is in contact with the outer peripheral surface 21a of the first cylindrical body 21 directly or indirectly. Thereby, the rigidity of the front fork 13 can be improved.

At least a part of the contact surface 61 of the support portion 60 is adhered to the outer peripheral surface 21a of the first cylindrical body 21. As a result, the rigidity of the front fork 13 can be improved by changing a specification of attaching the support portion 60, which is a separate member from the first cylindrical body 21, while using the front fork of the existing structure.

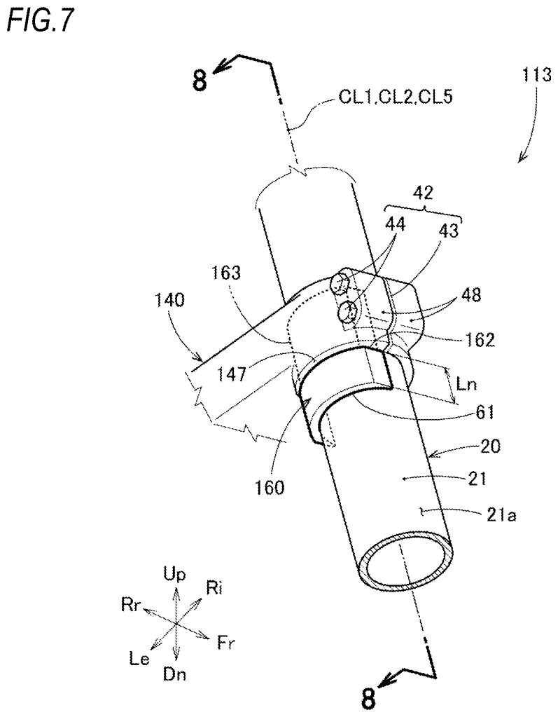

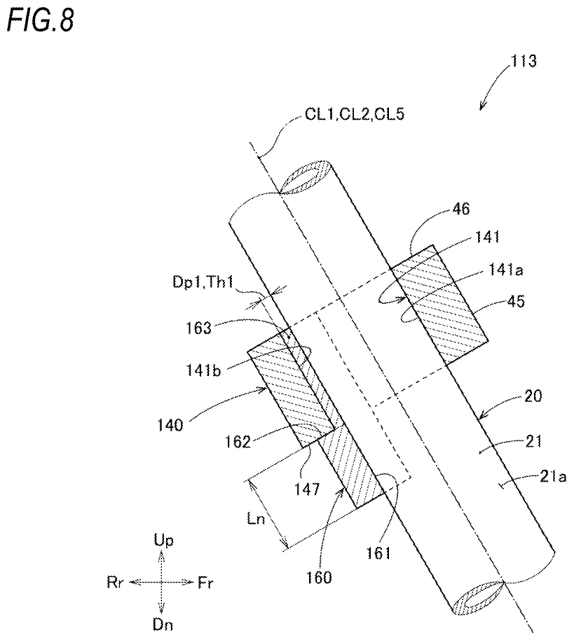

Next, a front fork 113 according to a second example will be described with reference to FIGS. 7 and 8.

### Second Example

FIG. 7 is a view illustrating the outer tube 21, a bottom bracket 140, and a support portion 160 of the front fork 113, and is a view corresponding to FIG. 3 for illustrating the front fork 13 according to the first example. FIG. 8 is a cross-sectional view taken along the line 8-8 of FIG. 7, is a view corresponding to FIG. 5 for illustrating the front fork 13 according to the first example. Hereinafter, the bottom bracket 140 may be referred to as a “fixing member 140”.

The front fork 113 according to the second example is characterized in that at least a part of the support portion 160 is sandwiched between the outer peripheral surface 21a of the first cylindrical body 21 of the shock absorber body 20 and an inner peripheral surface 141a of the fixing member 140, and other configurations are common to those of the front fork 13 according to the first example. In the description of the front fork 113 according to the second example, the same reference numerals and letters as those of the front fork 13 according to the first example are used, and detailed description thereof is omitted.

The support portion 160 is different from the support portion 60 according to the first example in that the support portion 160 integrally includes an extension portion 163 extending upward along the outer peripheral surface 21a of the outer tube 21, and the extension portion 163 is sandwiched between the outer peripheral surface 21a of the first cylindrical body 21 and the inner peripheral surface 141a of the fixing member.

The bottom bracket 140 includes a groove 141b in the inner peripheral surface 141a of a hole 141 into which the extension portion 163 is fitted. The extension portion 163 preferably extends from an upper surface 162 of the support portion 160 to the upper surface 46 of the bottom bracket 140. The shape and size of a contact surface 161 (inner peripheral surface 161) of the support portion 160 and a contact surface (inner peripheral surface) of the extension portion 163 are the same.

A thickness Th1 of the extension portion 163 and a depth Dp1 of the groove 141b are the same. The thickness Th1 of the extension portion 163 and the depth Dp1 of the groove 141b are uniform along an axis CL5 direction of the hole 141 and a circumferential direction of the shock absorber 20. By tightening the hole diameter changing mechanism 42, the extension portion 163 is sandwiched between the outer peripheral surface 21a of the outer tube 21 and a bottom surface of the groove 141b of the bottom bracket 140. Preferably, at least parts of the contact surfaces 161 and 161 of the support portions 160 and 160 are respectively adhered to the outer peripheral surfaces 21a and 21a of the outer tubes 21 and 21.

According to the second example, at least a part of the support portion 160 is sandwiched between the outer peripheral surface 21a of the first cylindrical body 21 and the bottom surface of the groove 141b of the fixing member 140. The upper surface 162 of the support portion 160 is in contact with a lower surface 147 of the fixing member 140. Accordingly, the support portion 160 can be easily installed between the first cylindrical body 21 and the fixing member 140. Other operations and effects according to the second example are the same as those of the first example.

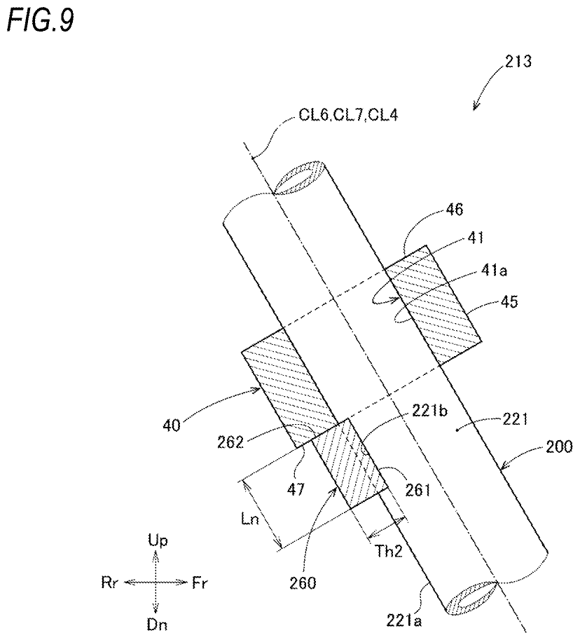

Next, a front fork 213 according to a third example will be described with reference to FIG. 9.

### Third Example

FIG. 9 is a view illustrating an outer tube 221 of a shock absorber body 200 with an axis line CL6 as an axis, the bottom bracket 40, and a support portion 260, which are provided in the front fork 213. FIG. 9 is a view corresponding to FIG. 5 for illustrating the front fork 13 according to the first example. An axis of the outer tube 221 is an axis CL7.

The front fork 213 according to the third example is characterized in that at least a part of the support portion 260 is fitted in an outer fitting portion 221b recessed from an outer peripheral surface 221a of the outer tube 221 of the shock absorber body 200, and other configurations are common to those of the front fork 13 according to the first example. In the description of the front fork 213 according to the third example, the same reference numerals and letters as those of the front fork 13 according to the first example are used, and detailed description thereof is omitted. Hereinafter, the outer tube 221 may be referred to as a “first cylindrical body 221”.

A contact surface 261 (inner peripheral surface 261) of the support portion 260 is in contact with a bottom surface of the outer fitting portion 221b. A thickness Th2 of the support portion 260 is thicker than a thickness of the support portion 60 by the amount that the support portion 260 is fitted into the outer fitting portion 221b. Preferably, at least a part of the contact surface 261 of the support portion 260 is adhered to the outer fitting portion 221b of the outer peripheral surface 221a of the outer tube 221.

According to the third example, the outer peripheral surface 221a of the first cylindrical body 221 includes the outer fitting portion 221b into which at least a part of the support portion 260 is fitted, and the outer fitting portion 221b is recessed from the outer peripheral surface 221a of the first cylindrical body 221. An upper surface 262 of the support portion 260 is in contact with a lower surface 47 of the fixing member 40. Accordingly, the support portion 260 can be easily installed between the first cylindrical body 21 and the fixing member 40. Other operations and effects according to the third example are the same as those of the first example.

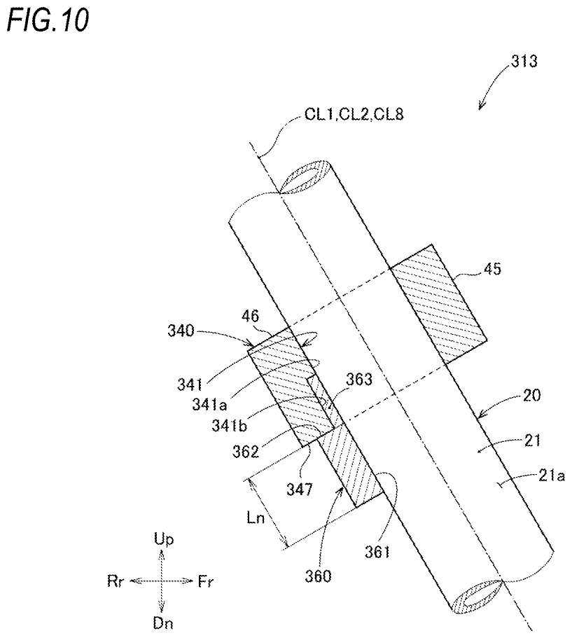

Next, a front fork 313 according to a fourth example will be described with reference to FIG. 10.

### Fourth Example

FIG. 10 is a view illustrating the outer tube 21, a bottom bracket 340, and a support portion 360 of the front fork 313, and is a view corresponding to FIG. 5 for illustrating the front fork 13 according to the first example. An axis of a hole 341 of the bottom bracket 340 is an axis CL8. Hereinafter, the bottom bracket 340 may be referred to as a “fixing member 340”.

The front fork 313 according to the fourth example is characterized in that at least a part of the support portion 360 is fitted in an inner fitting portion 341b recessed from an inner peripheral surface 341a (the inner peripheral surface 341a of the hole 341) of the bottom bracket 340, and other configurations are common to those of the front fork 13 according to the first example. In the description of the front fork 313 according to the fourth example, the same reference numerals and letters as those of the front fork 13 according to the first example are used, and detailed description thereof is omitted.

The support portion 360 differs from the support portion 60 according to the first example in that the support portion 360 integrally includes an extension portion 363 extending upward along the outer peripheral surface 21a of the outer tube 21 from an upper surface 362. A contact surface 361 (inner peripheral surface 361) of the support portion 360 is in contact with the outer peripheral surface 21a of the outer tube 21. Preferably, at least a part of the contact surface 361 of the support portion 360 is adhered to outer peripheral surface 21a of the outer tube 21.

According to the fourth example, the inner peripheral surface 341a of the fixing member 340 includes the inner fitting portion 341b for fitting at least a part of the support portion 360, and the inner fitting portion 341b is recessed from the inner peripheral surface 341a of the fixing member 340. The upper surface 362 of the support portion 360 is in contact with a lower surface 347 of the fixing member 340. Accordingly, the support portion 360 can be easily installed between the first cylindrical body 21 and the fixing member 340. Other operations and effects according to the fourth example are the same as those of the first example.

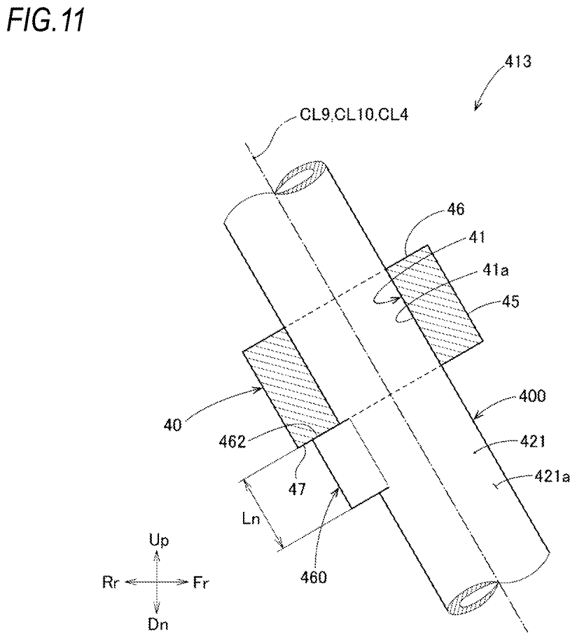

Next, a front fork 413 according to a fifth example will be described with reference to FIG. 11.

### Fifth Example

FIG. 11 is a view illustrating an outer tube 421, the bottom bracket 40, and a support portion 460 of the shock absorber body 400 provided on the front fork 413. FIG. 11 is a view corresponding to FIG. 5 for illustrating the front fork 13 according to the first example. An axis of the shock absorber body 400 is an axis CL9, and an axis of the outer tube 421 is an axis CL10. Hereinafter, the outer tube 421 may be referred to as a “first cylindrical body 421”.

The front fork 413 according to the fifth example is characterized in that the outer tube 421 and the support portion 460 of the shock absorber body 400 are integrally molded with the same material, and other configurations are common to those of the front fork 13 according to the first example. In the description of the front fork 413 according to the fifth example, the same reference numerals and letters as those of the front fork 13 according to the first example are used, and detailed description thereof is omitted.

The support portion 460 is a portion corresponding to the support portion 60 according to the first example, and is a portion protruding from an outer peripheral surface 421a of the outer tube 421 in a direction intersecting the axis CL10 of the outer tube 421. Materials for the outer tube 421 and the support portion 460 can be, for example, aluminum, aluminum alloy, and iron.

According to the fifth example, the first cylindrical body 421 and the support portion 460 are integrally molded from the same material, and the lower surface 47 of the fixing member 40 and an upper surface 462 of the support portion 460 are in contact with each other. Even with such a form, the same effects as in the first example can be obtained.

The front forks 13, 113, 213, 313, and 413 according to the present invention are not limited to the examples as long as the operations and effects of the present invention are exhibited.

In the above description, the front forks 13, 113, 213, 313, and 413, which are inverted forks, are exemplified, but the front forks of the present invention may be upright forks.

In the above description, the support portions 60, 160, 260, 360, and 460 are exemplified as supporting the outer peripheral surfaces 21a, 221a, and 421a of the outer tubes 21, 221, and 421, respectively, and in contact with the bottom brackets 40, 140, and 340. However, the present invention is not limited thereto. The support portions 60, 160, 260, 360, and 460 in the present invention may be configured to support the outer peripheral surfaces 21a, 221a, and 421a of the outer tubes 21, 221, and 421 and be in contact with the upper bracket 30 (fixing member 30). Here, when the support portions 60, 160, 260, 360, and 460 in the present invention is brought into contact with the upper bracket 30, the side where the contact surface pressure Sp between the support portions 60, 160, 260, 360, and 460 and the upper bracket 30 increases when the saddle-type vehicle 10 decelerates is the forward Fr side of the saddle-type vehicle 10 in the advancing direction. Therefore, when the support portions 60, 160, 260, 360, and 460 according to the present invention are brought into contact with the upper bracket 30, the support portions 60, 160, 260, 360, and 460 may be brought into contact with the forward Fr side in the advancing direction (for example, the direction of 0° with respect to the advancing direction).

The support portions 60, 160, 260, 360, and 460 in the present invention may be provided on the side where the contact surface pressure Sp between the support portions 60, 160, 260, 360, and 460 and the fixing members 40, 140, and 340 increases when the saddle-type vehicle 10 decelerates.

The front fork of the present invention is suitable for use in a saddle-type vehicle having two or three wheels.

1. A front fork, comprising:
a shock absorber body provided with a first cylindrical body formed in a cylindrical shape and a second cylindrical body movably provided relative to the first cylindrical body in an axial direction of the first cylindrical body;
a fixing member which is in contact with an outer peripheral surface of the first cylindrical body so that the shock absorber body is capable of being fixed to a vehicle on which the shock absorber body is mounted; and
a support portion which supports a part of the outer peripheral surface of the first cylindrical body and is in contact with the fixing member, wherein:
a length of a contact surface of the support portion in contact with the outer peripheral surface of the first cylindrical body in a circumferential direction of the first cylindrical body is half a peripheral length of the outer peripheral surface;
the support portion is provided at a portion where a contact surface pressure between the fixing member and the support portion increases when the vehicle decelerates, and is in direct contact with the outer peripheral surface of the first cylindrical body; and
at least a part of the support portion is adhered to the outer peripheral surface of the first cylindrical body.

2. The front fork according to claim 1, wherein
at least a part of the support portion is sandwiched between the outer peripheral surface of the first cylindrical body and an inner peripheral surface of the fixing member.

3. The front fork according to claim 1, wherein:
the outer peripheral surface of the first cylindrical body includes an outer fitting portion configured to fit at least a part of the support portion; and
the outer fitting portion is recessed from the outer peripheral surface of the first cylindrical body.

4. The front fork according to claim 1, wherein:
an inner peripheral surface of the fixing member includes an inner fitting portion configured to fit at least a part of the support portion; and
the inner fitting portion is recessed from the inner peripheral surface of the fixing member.

5. A front fork, comprising:
a shock absorber body provided with a first cylindrical body formed in a cylindrical shape and a second cylindrical body movably provided relative to the first cylindrical body in an axial direction of the first cylindrical body;
a fixing member which is in contact with an outer peripheral surface of the first cylindrical body so that the shock absorber body is capable of being fixed to a vehicle on which the shock absorber body is mounted; and
a support portion which supports a part of the outer peripheral surface of the first cylindrical body and is in contact with the fixing member, wherein:
a length of a contact surface of the support portion in contact with the outer peripheral surface of the first cylindrical body in a circumferential direction of the first cylindrical body is half a peripheral length of the outer peripheral surface;
the support portion is provided at a portion where a contact surface pressure between the fixing member and the support portion increases when the vehicle decelerates; and
the first cylindrical body and the support portion are integrally molded with a same material.

6. The front fork according to claim 1, wherein
the fixing member is disposed at an axially central portion or an axially lower end portion of the first cylindrical body.

7. The front fork according to claim 1, wherein
the support portion is in contact with a lower surface of the fixing member.

8. The front fork according to claim 2, wherein:
the outer peripheral surface of the first cylindrical body includes an outer fitting portion configured to fit at least a part of the support portion; and
the outer fitting portion is recessed from the outer peripheral surface of the first cylindrical body.

9. The front fork according to claim 2, wherein:
an inner peripheral surface of the fixing member includes an inner fitting portion configured to fit at least a part of the support portion; and
the inner fitting portion is recessed from the inner peripheral surface of the fixing member.

10. The front fork according to claim 5, wherein
the fixing member is disposed at an axially central portion or an axially lower end portion of the first cylindrical body.

11. The front fork according to claim 5, wherein
the support portion is in contact with a lower surface of the fixing member.

12. The front fork according to claim 6, wherein
the support portion is in contact with a lower surface of the fixing member.
